(19) United States
(12) Patent Application Publication
(10) Pub. No.: US 2025/0239626 A1
(43) Pub. Date: Jul. 24, 2025

(54) METHOD AND AUXILIARY DEVICE FOR COATING WITH ELECTRODE INK

(71) Applicant: HONDA MOTOR CO., LTD., Tokyo (JP)

(72) Inventors: Wataru KASHI, Saitama (JP); Yohei KATAOKA, Saitama (JP); Kento KUSATSUGU, Saitama (JP); Shinsuke CHOKYU, Saitama (JP)

(21) Appl. No.: 19/017,787

(22) Filed: Jan. 13, 2025

(30) Foreign Application Priority Data
Jan. 18, 2024 (JP) 2024-006302

(51) Int. Cl. H01M 4/88

(52) U.S. Cl. CPC H01M 4/8828

(57) ABSTRACT

To provide a method for coating with electrode ink which can reduce waste of electrode ink and improve product yield. An auxiliary device for coating with electrode ink includes an electrode ink receiver placed in front of a blade configured to apply the electrode ink in a travel direction, the electrode ink receiver extending in an intersection direction orthogonal to the travel direction and being configured to catch the electrode ink to be supplied, and regulators arranged at both ends of the electrode ink receiver in the intersection direction, extending along the travel direction, and each having a flat portion that regulates a direction of application of the electrode ink.

This application is based on and claims the benefit of priority from Japanese Patent Application No. 2024-006302, filed on 18 Jan. 2024, the content of which is incorporated herein by reference.

### BACKGROUND OF THE INVENTION

### Field of the Invention

The present invention relates to a method and an auxiliary device for coating with electrode ink.

### Related Art

A technique has been suggested in which when a base material is to be coated with electrode ink to produce a catalyst coated membrane (CCM), a blade is used (see, for example, Patent Document 1).
Patent Document 1: Japanese Unexamined Patent Application, Publication No. 2016-1568

### SUMMARY OF THE INVENTION

Coating of the base material using the blade may cause surplus electrode ink that has not been coated onto the base material to spread around the blade. Thus, it takes time to perform a process after coating, and at the same time, waste of the electrode ink occurs, resulting in lower yield.

(1) The present invention relates to an auxiliary device for coating with electrode ink (e.g., an auxiliary device 1 for coating with electrode ink). The device includes: an electrode ink receiver (e.g., an electrode ink receiver 4) placed in front of a blade (e.g., a blade 12) in a travel direction of the blade that is configured to apply the electrode ink, the electrode ink receiver extending in an intersection direction orthogonal to the travel direction, and being configured to catch the electrode ink (e.g., electrode ink 2) to be supplied; and regulators (e.g., regulators 5) arranged at both ends of the electrode ink receiver in the intersection direction, extending along the travel direction, and each having a flat portion (e.g., a flat portion 5a) that regulates a direction of application of the electrode ink.

(2) In one preferred aspect, a bottom portion (e.g., a bottom portion 41) of the electrode ink receiver is spaced apart upward from an upper surface of a base material (e.g., a base material 3) to be coated with the electrode ink.

(3) In one preferred aspect, the regulators are plate-shaped, and each has a curved portion (e.g., a curved portion 5b) corresponding to a curved front lower corner of the regulator in the travel direction.

(4) The present invention relates to a method for coating with electrode ink. The method includes: a placement step (e.g., a coating auxiliary device placement step S2) of placing a coating auxiliary device in front of a blade in a travel direction of the blade, the blade being configured to apply the electrode ink; and a coating step (e.g., a coating step S4) of moving the coating auxiliary device together with the blade to apply the electrode ink. The coating auxiliary device includes: an electrode ink receiver extending in an intersection direction orthogonal to the travel direction of the blade, the electrode ink receiver being configured to catch the electrode ink to be supplied; and regulators arranged at both ends of the electrode ink receiver in the intersection direction, extending along the travel direction, and each having a flat portion that regulates a direction of application of the electrode ink.

(5) In one preferred aspect, the method further includes: after the coating step, moving the electrode ink receiver away from the blade and collecting a surplus of the electrode ink (e.g., a collection step S5).

According to the aspect (1), the flat portion 5a of each regulator 5 substantially prevents the electrode ink 2 from spreading in the intersection direction CD. The electrode ink receiver 4 catching the electrode ink 2 to be supplied also substantially prevents the electrode ink 2 from spreading in the travel direction TD. This can keep the electrode ink 2 from leaking to an unintended region, can reduce waste of the electrode ink 2, and improves yield of a coated product, such as a CCM.

The aspect (2) can substantially prevent the bottom portion 41 from coming into contact with the base material 3 or the applied electrode ink 2 and thus disturbing the coated surface. The bottom portion 41 floating above the upper surface of the base material 3 prevents the friction between the bottom portion 41 and the base material 3 or the surface of the applied electrode ink 2. Thus, the coating auxiliary device 1 can be pushed by the blade 12 to move smoothly. This enables efficient coating, and improves yield.

According to the aspect (3), the front lower corner in the travel direction TD provided with the curved portion 5b substantially prevents the coating auxiliary device 1 from stopping due to dust, friction, or any other factor during the forward movement of the coating auxiliary device 1. Thus, the coating auxiliary device 1 can be pushed by the blade 12 to move smoothly. This enables efficient coating, and improves yield.

According to the aspect (4), the flat portion 5a of each regulator 5 substantially prevents the electrode ink 2 from spreading in the intersection direction CD. The electrode ink receiver 4 catching the electrode ink 2 to be supplied also substantially prevents the electrode ink 2 from spreading in the travel direction TD. This can keep the electrode ink 2 from leaking to an unintended region, can reduce waste of the protruding electrode ink 2, and improves yield of a coated product, such as a CCM.

The aspect (5) enables collection of the unused electrode ink 2, thus reducing waste of the electrode ink 2. Thus, advantages similar to those described above can be provided.

### BRIEF DESCRIPTION OF THE DRAWINGS

FIG. 1 is a perspective view illustrating an auxiliary device for coating with electrode ink according to an embodiment;

FIG. 2 is a plan view illustrating a state where coating with electrode ink is being performed by a method for coating with electrode ink according to the embodiment;

FIG. 3A is a side view illustrating a state where electrode ink is yet to be supplied to the auxiliary device for coating with electrode ink according to the embodiment;

FIG. 3B is a plan view illustrating the state where electrode ink is yet to be supplied to the auxiliary device for coating with electrode ink according to the embodiment;

FIG. 4A is a side view illustrating a state where electrode ink has been supplied to the auxiliary device for coating with electrode ink according to the embodiment;

FIG. 4B is a plan view illustrating the state where electrode ink has been supplied to the auxiliary device for coating with electrode ink according to the embodiment;

FIG. 5A is a side view illustrating a state where coating with electrode ink is being performed using the auxiliary device for coating with electrode ink according to the embodiment;

FIG. 5B is a plan view illustrating the state where coating with electrode ink is being performed using the auxiliary device for coating with electrode ink according to the embodiment;

FIG. 6A is a side view illustrating a state where electrode ink is being collected with the auxiliary device for coating with electrode ink according to this embodiment moved away from a blade; and

FIG. 6B is a plan view illustrating the state where electrode ink is being collected with the auxiliary device for coating with electrode ink according to this embodiment moved away from the blade.

### DETAILED DESCRIPTION OF THE INVENTION

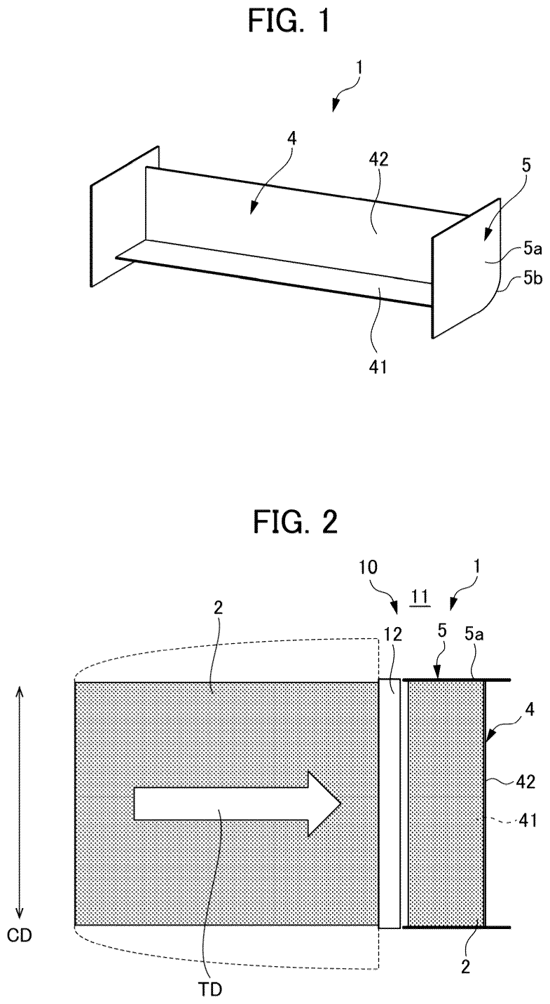

An embodiment of the present disclosure will be described in detail below with reference to the drawings. As illustrated in FIG. 1, a method for coating with electrode ink according to this embodiment is performed using an auxiliary device 1 for coating with electrode ink (hereinafter referred to also as the “coating auxiliary device 1”). The coating auxiliary device 1 may be used for any purpose as long as it is used for coating with electrode ink 2 using a blade coater 10. The coating auxiliary device 1 may be used, for example, in a step of coating a base material 3 with the electrode ink 2 to produce a catalyst coated membrane (CCM) for use in a fuel cell, water electrolysis, or a PEM pump or for any other purpose.

Non-limiting examples of the base material 3 include sheet-shaped thin films, such as a breathable base material and a mold releasing film. The base material 3 may be a base material for fuel cell gas diffusion, an electrolyte membrane for a fuel cell, or any other material. The base material 3 is placed on a coating table 11 of the blade coater 10 to be described later.

The electrode ink 2 is liquid containing a composite for forming an electrode, and may be, for example, liquid containing a catalyst carrier that supports a catalyst, ionomers (an electrolytic polymer, an electrolytic solution) having proton conductivity, and a dispersion solvent that disperses the catalyst carrier and the ionomers.

The blade coater 10 includes the coating table 11 and a blade 12, and is a device configured to coat the base material 3 set on the coating table 11 with the electrode ink 2 while moving the blade 12 in a fixed direction. The forward and backward directions in a travel direction TD in which the blade 12 moves as used herein are defined as directions toward the front and toward the back, respectively. A direction intersecting with the travel direction TD in which the blade 12 moves is referred to as the “intersection direction CD”.

As illustrated in FIG. 2, if the base material 3 is rectangular, the intersection direction CD is the width direction (lateral direction) of the base material 3. The coating table 11 has a flat surface similar to the surface of a glass plate, for example. The blade 12 is attached to the coating table 11 such that the longitudinal direction of the blade 12 extends in the intersection direction CD and such that the lateral direction of the blade 12 is substantially orthogonal to the surface of the coating table 11. The blade 12 has a tip end positioned to be close to the surface of the base material 3, and moves while coating the upper surface of the base material 3 with the electrode ink 2 supplied to the coating auxiliary device 1 to be described later. The dimension of the blade 12 along the intersection direction CD becomes equal to the dimension of the CCM in the intersection direction CD.

The coating auxiliary device 1 is disposed in front of the blade 12 in the travel direction TD as illustrated in FIG. 2, and moves with the blade 12. The coating auxiliary device 1 includes an electrode ink receiver 4 and regulators 5.

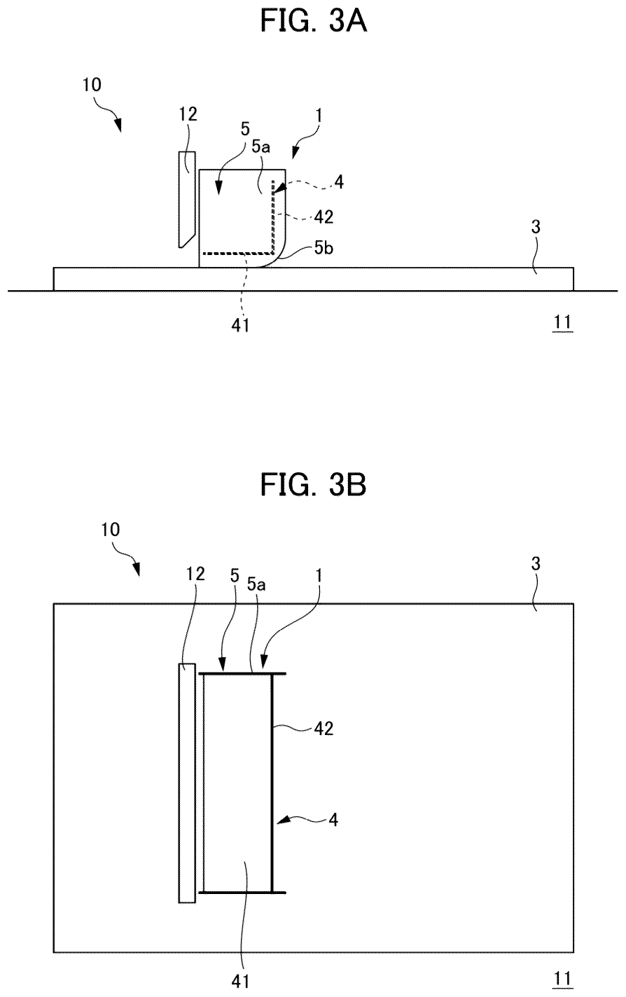

The electrode ink receiver 4 is disposed in front of the blade 12 in the travel direction TD, and extends in the intersection direction CD orthogonal to the travel direction TD. The electrode ink receiver 4 is laterally long so that the intersection direction CD corresponds to the longitudinal direction thereof. The electrode ink receiver 4 is a portion of the coating auxiliary device 1 to which the electrode ink 2 for coating of the base material 3 is supplied and which catches the electrode ink 2. As illustrated in, for example, FIGS. 1 and 3A, the electrode ink receiver 4 is substantially L-shaped in a side view, and includes a bottom portion 41 and a vertical wall portion 42.

The bottom portion 41 is a substantially rectangular plate surface the longitudinal direction of which is along the intersection direction CD and the lateral direction of which is along the travel direction TD of the blade 12. As illustrated in FIG. 3A, the bottom portion 41 is spaced apart upward from the upper surface of the base material 3, and is not in contact with the base material 3. As illustrated in FIG. 3B, the dimension of the bottom portion 41 along the intersection direction CD is approximately slightly shorter than the dimension of the blade 12 along the intersection direction CD.

The vertical wall portion 42 stands upright from the front end of the bottom portion 41, and is plate-shaped. The vertical wall portion 42 is connected to the front end of the bottom portion 41, and has the same dimension in the intersection direction CD as that of the bottom portion 41.

The regulators 5 are arranged at both ends of the electrode ink receiver 4 in the intersection direction CD. Each regulator 5 is plate-shaped, and has a flat portion 5a and a curved portion 5b. The regulators 5 are arranged such that both ends of the electrode ink receiver 4 are sandwiched between a pair of the flat portions 5a. The flat portion 5a has a surface that extends along the travel direction TD. The flat portion 5a is generally in the shape of a quadrangle that has a dimension along the travel direction TD shorter than the longitudinal dimension of the electrode ink receiver 4. The curved portion 5b corresponds to the curved front lower corner of the flat portion 5a.

A method for coating with electrode ink using the coating auxiliary device 1 described above will be described. As illustrated in FIGS. 3A and 3B, the base material 3 is placed on the coating table 11 of the blade coater 10 (a base material placement step S1). The coating auxiliary device 1 is placed in front of the blade 12 in the travel direction TD with the tip end of the blade 12 being brought close to the upper surface of the base material 3 (a coating auxiliary device placement step S2).

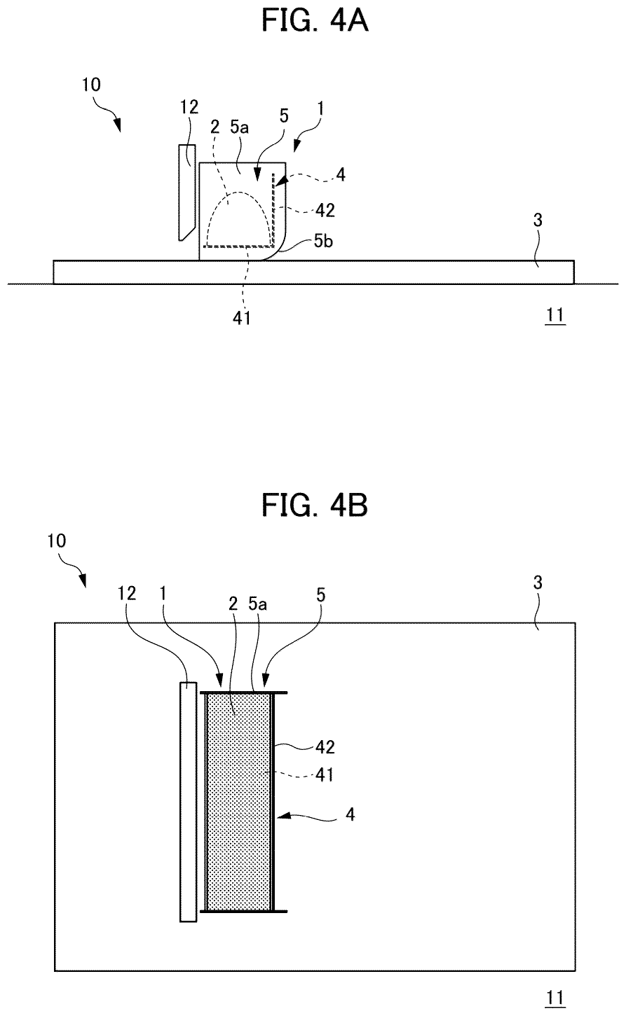

As illustrated in FIGS. 4A and 4B, the electrode ink 2 is supplied to the upper surface of the bottom portion 41 of the electrode ink receiver 4 of the coating auxiliary device 1, and is thus supplied from the bottom portion 41 to the gap between the blade 12 and the coating auxiliary device 1 (an electrode ink supply step S3). Then, coating with the electrode ink 2 is started by the blade coater 10 (a coating step S4). In the coating step S4, the movement of the blade 12, on which the regulators 5 of the coating auxiliary device 1 abut, allows the coating auxiliary device 1 to be pushed forward together with the blade 12 and to move forward along with the blade 12. The curved portion 5b of each regulator 5 of the coating auxiliary device 1 prevents the front lower corner of the regulator 5 from being angular. Thus, the coating auxiliary device 1 is more likely to move smoothly without being caught.

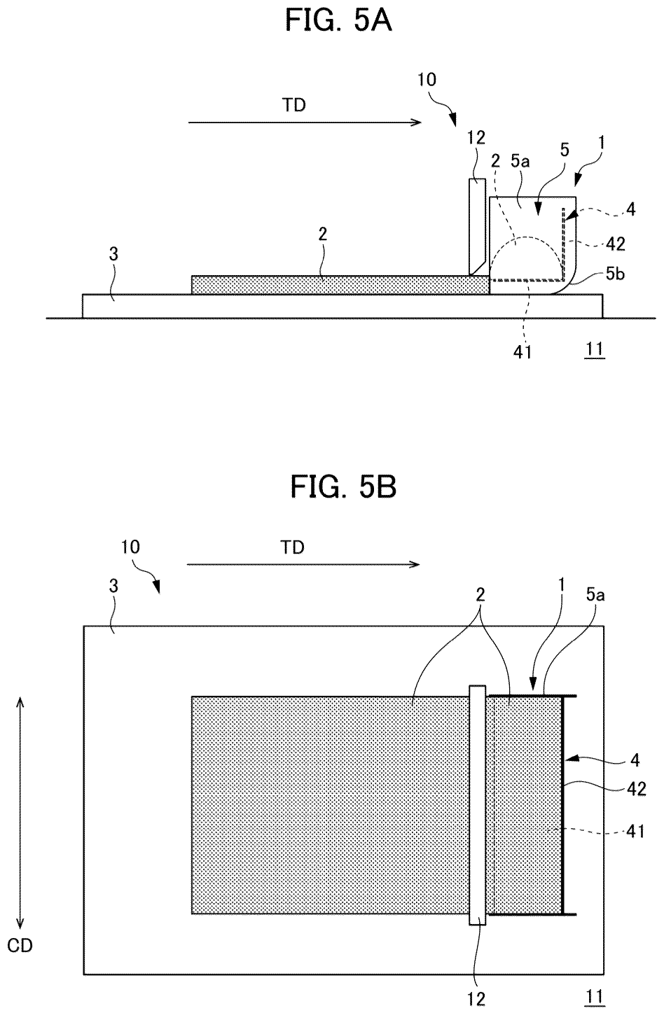

As illustrated in FIGS. 5A and 5B, the travel of the blade 12 allows a region behind the blade 12 to be coated with the electrode ink 2. At this time, the absence of the regulators 5 of the coating auxiliary device 1 would cause the electrode ink 2 to protrude in the intersection direction CD as indicated by the dashed lines in FIG. 2. This would lead to the formation of an irregular coating surface that is larger than an intended coating surface. However, the flat portion 5a of each regulator 5 keeps the electrode ink 2 from spreading outward in the intersection direction CD, and regulates the direction of coating with the electrode ink 2.

The base material 3 is coated with the electrode ink 2 supplied to the electrode ink receiver 4 through the gap between the electrode ink receiver 4 and the blade 12 while the blade 12 adjusts the thickness of a coating film. Meanwhile, the vertical wall portion 42 keeps the electrode ink 2 from spreading forward in the travel direction TD.

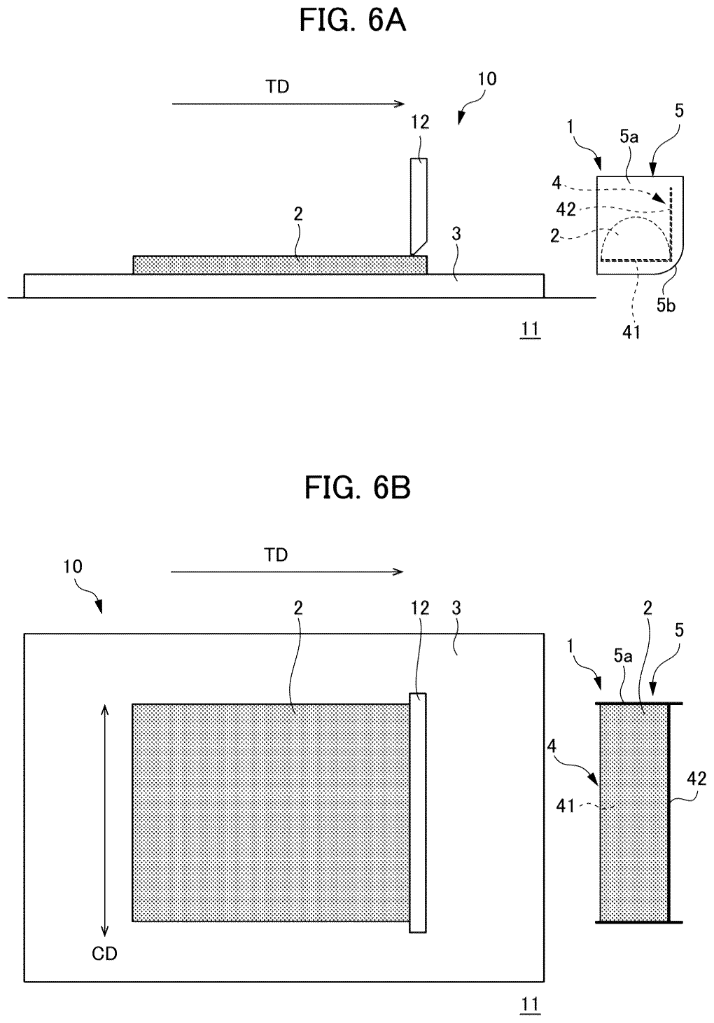

As illustrated in FIGS. 6A and 6B, the coating auxiliary device 1 is moved away from the blade 12 after the coating step S4. A surplus of the electrode ink 2 that has not been coated onto the base material 3 is accumulated at the bottom portion 41 of the electrode ink receiver 4, and is thus collected (a collection step S5).

According to this embodiment, the following advantages are provided.

(1) The auxiliary device 1 for coating with electrode ink includes the electrode ink receiver 4 placed in front of the blade 12 in the travel direction TD, extending in the intersection direction CD orthogonal to the travel direction TD, the electrode ink receiver 4 being configured to catch the electrode ink 2 to be supplied, and the blade 12 being configured to apply the electrode ink 2, and the regulators 5 arranged at both ends of the electrode ink receiver 4 in the intersection direction CD, extending along the travel direction TD, and each having a flat portion 5a that regulates the direction of application of the electrode ink 2. The flat portion 5a of each regulator 5 substantially prevents the electrode ink 2 from spreading in the intersection direction CD. The electrode ink receiver 4 catching the electrode ink 2 to be supplied also substantially prevents the electrode ink 2 from spreading in the travel direction TD. This can keep the electrode ink 2 from leaking to an unintended region, can reduce waste of the electrode ink 2, and improves yield of a coated product, such as a CCM.

(2) According to this embodiment, the bottom portion 41 of the electrode ink receiver 4 is spaced apart upward from the upper surface of the base material 3 to be coated with the electrode ink 2. This can substantially prevent the bottom portion 41 from coming into contact with the base material 3 or the applied electrode ink 2 and thus disturbing the coated surface. The bottom portion 41 floating above the upper surface of the base material 3 prevents the friction between the bottom portion 41 and the base material 3 or the surface of the applied electrode ink 2. Thus, the coating auxiliary device 1 can be pushed by the blade 12 to move smoothly. This enables efficient coating, and improves yield.

(3) According to this embodiment, the flat portion 5a is plate-shaped, and includes the curved portion 5b corresponding to the curved front lower corner of the flat portion 5a in the travel direction TD. The front lower corner in the travel direction TD provided with the curved portion 5b substantially prevents the coating auxiliary device 1 from stopping due to dust, friction, or any other factor during the forward movement of the coating auxiliary device 1. Thus, the coating auxiliary device 1 can be pushed by the blade 12 to move smoothly. This enables efficient coating, and improves yield.

(4) According to this embodiment, the method for coating with the electrode ink 2 includes the coating auxiliary device placement step (S2) of placing the coating auxiliary device 1 in front of the blade 12 in the travel direction TD, the blade 12 being configured to apply the electrode ink 2, and the coating step (S4) of moving the coating auxiliary device 1 together with the blade 12 to apply the electrode ink 2. The coating auxiliary device 1 includes the electrode ink receiver 4 extending in the intersection direction CD orthogonal to the travel direction TD of the blade 12 and being configured to catch the electrode ink 2 to be supplied, and the regulators 5 arranged at both ends of the electrode ink receiver 4 in the intersection direction CD, extending along the travel direction TD, and each having a flat portion 5a that regulates the direction of coating with the electrode ink 2. The flat portion 5a of each regulator 5 substantially prevents the electrode ink 2 from spreading in the intersection direction CD. The electrode ink receiver 4 catching the electrode ink 2 to be supplied also substantially prevents the electrode ink 2 from spreading in the travel direction TD. This can keep the electrode ink 2 from leaking to an unintended region, can reduce waste of the protruding electrode ink 2, and improves yield of a coated product, such as a CCM.

(5) According to this embodiment, the method further includes the collection step (S5) of, after the coating step (S4), moving the electrode ink receiver 4 away from the blade 12 and collecting a surplus of the electrode ink 2. This enables collection of the unused electrode ink 2, thus reducing waste of the electrode ink 2. Thus, advantages similar to those described above can be provided.

The present invention is not limited to the foregoing embodiment, and as long as it is possible to achieve the object of the present invention, variations, modifications and the like are included in the present invention. For example, the flat portions 5a are generally in the shape of a quadrangle in the foregoing embodiment. However, as long as the flat portions 5a each have a surface extending along the travel direction TD, the flat portions 5a may have any shape.

### EXPLANATION OF REFERENCE NUMERALS

1 Coating Auxiliary Device
2 Electrode Ink
3 Base Material
4 Electrode Ink Receiver
5 Regulator
5a Flat Portion
5b Curved Portion
12 Blade

What is claimed is:

1. An auxiliary device for coating with electrode ink, the device comprising:
an electrode ink receiver placed in front of a blade in a travel direction of the blade that is configured to apply the electrode ink, the electrode ink receiver extending in an intersection direction orthogonal to the travel direction and being configured to catch the electrode ink to be supplied; and
regulators arranged at both ends of the electrode ink receiver in the intersection direction, extending along the travel direction, and each having a flat portion that regulates a direction of application of the electrode ink.

2. The device of claim 1, wherein
a bottom portion of the electrode ink receiver is spaced apart upward from an upper surface of a base material to be coated with the electrode ink.

3. The device of claim 1, wherein
the regulators are plate-shaped, and each has a curved portion corresponding to a curved front lower corner of the regulator in the travel direction.

4. The device of claim 2, wherein
the regulators are plate-shaped, and each has a curved portion corresponding to a curved front lower corner of the regulator in the travel direction.

5. A method for coating with electrode ink, the method comprising:
a placement step of placing a coating auxiliary device in front of a blade in a travel direction of the blade, the blade being configured to apply the electrode ink; and
a coating step of moving the coating auxiliary device together with the blade to apply the electrode ink, the coating auxiliary device including:
an electrode ink receiver extending in an intersection direction orthogonal to the travel direction of the blade, the electrode ink receiver being configured to catch the electrode ink to be supplied; and
regulators arranged at both ends of the electrode ink receiver in the intersection direction, extending along the travel direction, and each having a flat portion that regulates a direction of application of the electrode ink.

6. The method of claim 5 further comprising:
after the coating step, moving the electrode ink receiver away from the blade and collecting a surplus of the electrode ink.
